(19) United States
(12) Patent Application Publication
(10) Pub. No.: US 2026/0005448 A1
(43) Pub. Date: Jan. 1, 2026

(54) ANTENNA UNIT AND PREPARATION METHOD THEREFOR, ANTENNA ARRAY, AND ELECTRONIC DEVICE

(71) Applicants: Beijing BOE Technology Development Co., Ltd., Beijing (CN); BOE Technology Group Co., Ltd., Beijing (CN)

(72) Inventors: Qianhong WU, Beijing (CN); Yali WANG, Beijing (CN); Guoqiang TANG, Beijing (CN)

(21) Appl. No.: 18/881,273

(22) PCT Filed: May 28, 2024
(86) PCT No.: PCT/CN2024/095743

§ 371 Date: Jan. 4, 2025

(30) Foreign Application Priority Data
Jun. 25, 2023 (CN) 202310756212.1

(51) Int. Cl. H01Q 21/06; H01Q 9/04

(52) U.S. Cl. CPC H01Q 21/065; H01Q 9/0407

(57) ABSTRACT

An antenna unit and a preparation method therefor, an antenna array, and an electronic device. The antenna array comprises at least one antenna unit. The antenna unit comprises: a substrate (2) comprising a first surface and a second surface which are arranged opposite to each other in the thickness direction of the substrate (2); a first radiation patch (3) disposed on the first surface of the substrate (2); feed lines (4) disposed on the first surface of the substrate (2), the feed lines (4) being connected to the first radiation patch (3); and a second radiation patch (5) suspended on the side of the first radiation patch (3) away from the substrate (2), the orthographic projection of the second radiation patch (5) on the substrate (2) overlapping the orthographic projection of the first radiation patch (3) on the substrate (2).

### CROSS-REFERENCE TO RELATED APPLICATION

The present application is a U.S. National Phase Entry of International Application No. PCT/CN2024/095743 having an international filing date of May 28, 2024, which claims priority to Chinese patent application No. 202310756212.1, filed to the CNIPA on Jun. 25, 2023 and entitled “Antenna Unit and Preparation Method Therefor, Antenna Array, and Electronic Device”. Contents of the above-identified applications are incorporated into the present application by reference.

### TECHNICAL FIELD

Embodiments of the present disclosure relate to, but are not limited to, the field of communication technologies, and particularly relate to an antenna unit and a preparation method therefor, an antenna array, and an electronic apparatus.

### BACKGROUND

Antennas are widely used in communication, navigation, radar and other communication fields. At present, with the development of electronic apparatus, antennas tend to be more and more miniaturized, making spacing between various structures in antennas more and more compact, which will cause mutual coupling effect. However, the strong mutual coupling effect will change the current amplitude and phase distribution of the antenna, resulting in poor antenna performance.

### SUMMARY

The following is a summary of subject matters described in the present disclosure in detail. This summary is not intended to limit the protection scope of claims.

In a first aspect, an embodiment of the present disclosure provides an antenna unit including: a base substrate, including a first surface and a second surface provided opposite to each other in a thickness direction of the base substrate; a first radiation patch, provided on the first surface of the base substrate; a feeder line, provided on the first surface of the base substrate, the feeder line being connected to the first radiation patch; and a second radiation patch, suspended on a side of the first radiation patch away from the base substrate, an orthographic projection of the second radiation patch on the base substrate overlapping with an orthographic projection of the first radiation patch on the base substrate. At least one of the first radiation patch and the second radiation patch is provided with a separation structure.

In an exemplary implementation, at least one second separation structure is provided on the second radiation patch, and the second separation structure is a groove-like structure or a through-hole structure.

In an exemplary implementation, a shape of the groove-like structure includes a U-shape.

In an exemplary implementation, a shape of the through-hole structure includes a rectangular shape.

In an exemplary implementation, part or all of the second separation structure is curved in a direction towards the base substrate.

In an exemplary implementation, the second radiation patch includes at least one corner part, and the second separation structure is provided in at least one corner part area of the second radiation patch.

In an exemplary implementation, a shape of the second radiation patch is rectangular, and second separation structures are respectively provided in four corner part areas of the second radiation patch.

In an exemplary implementation, at least one protrusion part is provided on the second radiation patch, and part or all of the second separation structure is provided on the protrusion part.

In an exemplary implementation, the protrusion part is curved in a direction towards the base substrate, and is provided obliquely relative to the second radiation patch.

In an exemplary implementation, a shape of the second radiation patch is polygonal, the second radiation patch includes a first edge part and a second edge part located between adjacent first edge parts, and the protrusion part is provided on the first edge part.

In an exemplary implementation, a ratio of a first length of the second separation structure to a second length of the second separation structure is 0.5 to 2, the first length is a distance feature in a fourth direction, the second length is a distance feature in a fifth direction, the fourth direction and the fifth direction are both parallel to the base substrate, and the fourth direction intersects with the fifth direction.

In an exemplary implementation, the orthographic projection of the first radiation patch on the base substrate is located within the orthographic projection of the second radiation patch on the base substrate.

In an exemplary implementation, the feeder line is integrally connected with the first radiation patch.

In an exemplary implementation, an orthographic projection of the feeder line on the base substrate is located within the orthographic projection of the second radiation patch on the base substrate.

In an exemplary implementation, the feeder line includes a first feeder line and a second feeder line, the first feeder line and the second feeder line being located on the same side of the first radiation patch.

In an exemplary implementation, at least one first separation structure is provided on the first radiation patch, the first separation structure, the first feeder line, and the second feeder line are located on the same side of the first radiation patch, and the first separation structure is located between the first feeder line and the second feeder line.

In an exemplary implementation, the first separation structure includes a groove-like structure.

In an exemplary implementation, a ratio of a third length of the first separation structure to a fourth length of the first separation structure is 1 to 4, the third length is a distance feature in a second direction, the fourth length is a distance feature in a first direction, the first direction and the second direction are both parallel to the base substrate, and the first direction intersects with the second direction.

In an exemplary implementation, a distance from a central axis of the first separation structure to an edge of the first feeder line is L1, a distance from the central axis of the first separation structure to an edge of the second feeder line is L2, and a ratio of the L2 to the L1 is 3 to 4.

In an exemplary implementation, a shape of the first radiation patch includes a rectangular shape, and at least one corner part of the first radiation patch is a rounded corner.

In an exemplary implementation, at least one separation wall is provided on an edge part of the base substrate, the separation wall protruding from the first surface of the base substrate.

In an exemplary implementation, the base substrate includes a first edge and a second edge provided opposite to each other, separation walls are provided at two ends of the first edge and two ends of the second edge, respectively; or, the separation walls are provided at a middle of the first edge and a middle of the second edge, respectively.

In an exemplary implementation, a connection hole is provided in the separation wall.

In an exemplary implementation, a reflection plate is further included, the reflection plate is provided on the second surface of the base substrate, the reflection plate is made of a conductive material, and the reflection plate is grounded.

In an exemplary implementation, the base substrate is a glass base substrate.

In a second aspect, an embodiment of the present disclosure further provides an antenna array including multiple antenna units described above, and a power divider circuit. The power divider circuit includes a one-to-multiple-equal power division circuit. The one-to-multiple-equal power division circuit includes a main line and multiple branch lines. First ends of the multiple branch lines are electrically connected to the main line, second ends of the multiple branch lines are connected in one-to-one correspondence with feeder lines of the multiple antenna units, and the power divider circuit is configured to provide signals of substantially equal power to the multiple antenna units.

In an exemplary implementation, three antenna units are included, the power divider circuit includes a one-to-three-equal power division circuit, the one-to-three-equal power division circuit includes a main line and three branch lines, first ends of the three branch lines are connected to the main line, and second ends of the three branch lines are connected in one-to-one correspondence with the feeder lines of the three antenna units.

In a third aspect, an embodiment of the present disclosure further provides an electronic apparatus including the aforementioned antenna unit.

In a fourth aspect, an embodiment of the present disclosure provides a method for preparing an antenna unit, including: forming a first radiation patch and a feeder line on a base substrate, the feeder line being connected to the first radiation patch; and forming a second radiation patch on a side of the first radiation patch away from the base substrate; the second radiation patch being suspended on the first radiation patch, an orthographic projection of the second radiation patch on the base substrate overlapping with an orthographic projection of the first radiation patch on the base substrate, and at least one of the first radiation patch and the second radiation patch being provided with a separation structure

Other aspects of the present disclosure may be comprehended after the drawings and the detailed descriptions are read and understood

### BRIEF DESCRIPTION OF DRAWINGS

Accompanying drawings are intended to provide an understanding of technical solutions of the present application and form a part of the specification, and are used to explain the technical solutions of the present application together with embodiments of the present application, and do not constitute a limitation on the technical solutions of the present application.

FIG. 1a is a top view of an antenna unit according to an exemplary embodiment of the present disclosure.

FIG. 1b is a top view of a first radiation patch of the antenna unit in FIG. 1a.

FIG. 1c is a top view of a second radiation patch of the antenna unit in FIG. 1a.

FIG. 2 is a top view of another antenna unit according to an exemplary embodiment of the present disclosure.

FIG. 3 is a top view of another antenna unit according to an exemplary embodiment of the present disclosure.

FIG. 4a is a top view of another antenna unit according to an exemplary embodiment of the present disclosure.

FIG. 4b is a top view of a first radiation patch of the antenna unit in FIG. 4a.

FIG. 5 is a schematic structural diagram of another antenna unit according to an exemplary embodiment of the present disclosure.

FIG. 6 is a top view of the antenna unit in FIG. 5.

FIG. 7 is a side view of the antenna unit in FIG. 5.

FIG. 8a is a top view of a first radiation patch of the antenna unit in FIG. 5.

FIG. 8b is a top view of a second radiation patch of the antenna unit in FIG. 5.

FIG. 9a is a graph of a standing wave ratio of corresponding ports of a first feeder line and a second feeder line of the antenna unit in FIG. 5.

FIG. 9b is a graph of an isolation between corresponding ports of a first feeder line and a second feeder line of the antenna unit in FIG. 5.

FIG. 9c is a graph of a perpendicular plane gain and a wave width of the antenna unit in FIG. 5.

FIG. 9d is a graph of a horizontal plane gain and a wave width of the antenna unit in FIG. 5.

FIG. 9e is a graph of a cross-polarization ratio in an axial direction and ±60° of the antenna unit in FIG. 5.

FIG. 9f is a graph of a front-to-back ratio of the antenna unit in FIG. 5.

FIG. 10a is a schematic structural diagram of another antenna unit according to an exemplary embodiment of the present disclosure.

FIG. 10b is a schematic structural diagram of a second radiation patch of the antenna unit in FIG. 10a.

FIG. 11a is a schematic structural diagram of another antenna unit according to an exemplary embodiment of the present disclosure.

FIG. 11b is a schematic structural diagram of a second radiation patch of the antenna unit in FIG. 11a.

FIG. 12 is a schematic structural diagram of an antenna array according to an exemplary embodiment of the present disclosure.

FIG. 13a is a first schematic structural diagram of a one-to-three-equal power division circuit of an antenna array according to an exemplary embodiment of the present disclosure.

FIG. 13b is a second schematic structural diagram of a one-to-three-equal power division circuit of an antenna array according to an exemplary embodiment of the present disclosure.

FIG. 14a is a graph of a standing wave ratio of input ports on two sides of a 1-to-3 antenna array shown in FIG. 12.

FIG. 14b is a graph of an isolation between input ports on two sides of a 1-to-3 antenna array shown in FIG. 12.

FIG. 14c is a graph of a perpendicular plane gain and a wave width of a 1-to-3 antenna array shown in FIG. 12.

FIG. 14d is a graph of a horizontal plane gain and a wave width of a 1-to-3 antenna array shown in FIG. 12.

FIG. 14e is a graph of a cross-polarization ratio of a 1-to-3 antenna array shown in FIG. 12.

FIG. 14f is a graph of a front-to-back ratio of a 1-to-3 antenna array shown in FIG. 12.

### DETAILED DESCRIPTION

To make objectives, technical solutions, and advantages of the present disclosure clearer, embodiments of the present disclosure will be described in detail below with reference to the accompanying drawings. It is to be noted that implementations may be implemented in multiple different forms. Those of ordinary skills in the art may easily understand such a fact that modes and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

In the accompanying drawings, a size of each constituent element, a thickness of a layer, or a region may be sometimes exaggerated for clarity. Therefore, an implementation of the present disclosure is not necessarily limited to the size, and a shape and a size of each component in the drawings do not reflect an actual scale. In addition, the accompanying drawings schematically illustrate ideal examples, and an implementation of the present disclosure is not limited to shapes, numerical values, or the like shown in the drawings.

Ordinal numerals “first”, “second”, “third”, and the like in the specification are set not to form limits in numbers but only to avoid confusion between constituent elements.

In the present specification, for convenience, expressions “central”, “above”, “below”, “front”, “back”, “vertical”, “horizontal”, “top”, “bottom”, “inside”, “outside”, and the like for indicating directional or positional relationships are used to illustrate positional relationships between the constituent elements with reference to the accompanying drawings, they are employed for ease of description of the specification and simplification of the description only, but do not indicate or imply that the referred device or element must have a particular orientation, or is constructed and operated in a particular orientation, and therefore cannot be construed as limitations on the present disclosure. The positional relationships between the constituent elements may be changed as appropriate based on a direction according to which each constituent element is described. Therefore, appropriate replacements based on situations are allowed, which is not limited to the expressions in the specification.

In the present specification, unless otherwise explicitly specified and defined, terms “mounting”, “coupling”, and “connection” should be understood in a broad sense. For example, it may be a fixed connection, or a detachable connection, or an integral connection; it may be a mechanical connection or an electrical connection; it may be a direct connection, or an indirect connection through a middleware, or an internal communication between two elements. Those of ordinary skills in the art may understand specific meanings of the above terms in the present disclosure according to specific situations.

In the present specification, “parallel” refers to a state in which an angle formed by two straight lines is above −10° and below 10°, and thus may include a state in which the angle is above −5° and below 5°. In addition, “perpendicular” refers to a state in which an angle formed by two straight lines is above 80° and below 100°, and thus may include a state in which the angle is above 85° and below 95°.

In the present disclosure, “about” means that a boundary is not defined so strictly and numerical values within process and measurement error ranges are allowed.

An embodiment of the present disclosure provides an antenna unit, including: a base substrate, including a first surface and a second surface provided opposite to each other in a thickness direction of the base substrate; a first radiation patch, provided on the first surface of the base substrate; a feeder line, provided on the first surface of the base substrate, the feeder line being connected to the first radiation patch; and a second radiation patch, suspended on a side of the first radiation patch away from the base substrate. An orthographic projection of the second radiation patch on the base substrate overlaps with an orthographic projection of the first radiation patch on the base substrate. At least one of the first radiation patch and the second radiation patch is provided with a separation structure.

Solution of this embodiment will be described below through some examples.

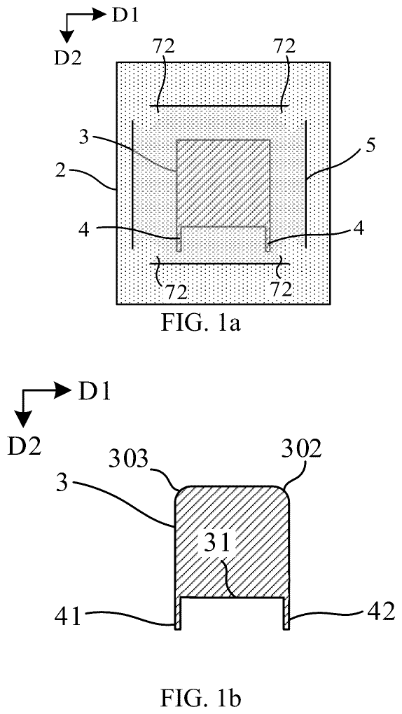

FIG. 1a is a top view of an antenna unit according to an exemplary embodiment of the present disclosure. In an exemplary embodiment, as shown in FIG. 1, the antenna unit includes a reflection plate 1, a base substrate 2, a first radiation patch 3, a feeder line 4, and a second radiation patch 5.

In an exemplary embodiment, as shown in FIG. 1, a shape of the base substrate 2 may be rectangular. The base substrate 2 includes a first surface and a second surface provided opposite to each other in a thickness direction of the base substrate. The first radiation patch 3 and the feeder line 4 are provided on the first surface of the base substrate 2 and the first surface of the base substrate 2 is in contact with the first radiation patch 3 and the feeder line 4. The reflection plate 1 is provided on the second surface of the base substrate 2 and the second surface of the base substrate 2 is in contact with the reflection plate 1.

In an exemplary embodiment, the first radiation patch 3 and the feeder line 4 may be formed on the first surface of the base substrate 2 by a vapor deposition process, and the reflection plate 1 may be obtained on the second surface of the base substrate 2 by a metal integrated molding process.

In an exemplary embodiment, the base substrate 2 is a glass base substrate. For example, a dielectric constant of the glass base substrate is 5.5, a dielectric loss angle tangent of the glass base substrate is 0.004, and a thickness of the glass base substrate is 0.5 mm.

The antenna unit of an embodiment of the present disclosure adopts the glass base substrate, which effectively reduces a weight and cost of the antenna unit compared with a metal vibrator (sheet metal/die-casting), and may realize an integration of more antenna units. For example, a quantity of antenna units is 192, 256 or 384, and the glass base substrate may effectively reduce a weight and cost of the antenna units.

In an exemplary embodiment, the antenna unit of an embodiment of the present disclosure may be integrated into a 5G base station to achieve a purpose of energy saving and cost reduction.

FIG. 1b is a top view of a first radiation patch of the antenna unit in FIG. 1a. In an exemplary embodiment, as shown in FIG. 1b, a shape of the first radiation patch 3 may be rectangular, and a thickness of the first radiation patch 3 may be approximately 1 micron to 2 microns. A surface of the first radiation patch 3 is in contact with the first surface of the base substrate 2. An orthographic projection of the first radiation patch 3 on the base substrate 2 is located within an orthographic projection of the second radiation patch 5 on the base substrate 2. The first radiation patch 3 is electrically connected to the feeder line 4, and the first radiation patch 3 may emit a signal through an excitation signal applied by the feeder line 4.

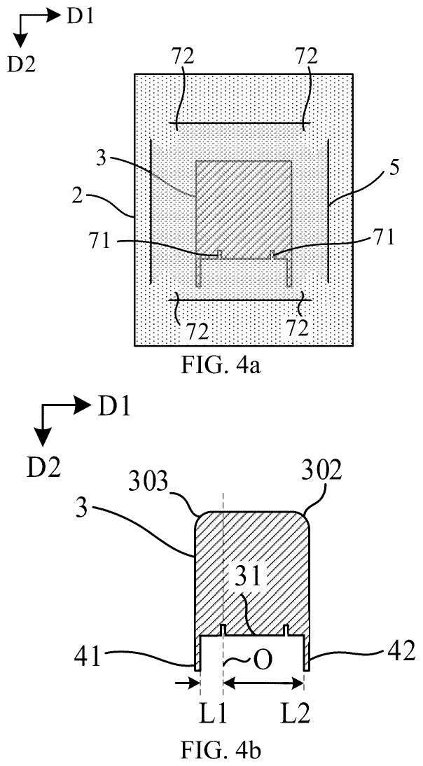

In an exemplary embodiment, a shape of the first radiation patch 3 includes a rectangle, and at least one corner part of the first radiation patch 3 is a rounded corner. For example, the first radiation patch 3 includes a first corner part 302 and a second corner part 303 located on a side in an opposite direction of a second direction D2, and both of the first corner part 302 and the second corner part 303 may be rounded corners, as shown in FIG. 4.

In an exemplary embodiment, the feeder line 4 includes a first feeder line 41 and a second feeder line 42, and both of the first feeder line 41 and the second feeder line 42 are connected to an edge part 31 of the first radiation patch 3.

In the antenna unit of an embodiment of the present disclosure, the antenna unit is excited through the first feeder line and the second feeder line, each radiating to generate polarization of ±45°.

In an exemplary embodiment, a first end of the first feeder line 41 is integrally connected with a first end of the edge part 31, a second end of the first feeder line 41 extends in the second direction D2, and an orthographic projection of the first feeder line 41 on the base substrate does not overlap with an orthographic projection of the second radiation patch 5 on the base substrate. Herein, being integrally connected refers to being prepared by using the same material through the same preparation process.

In an exemplary embodiment, a first end of the second feeder line 42 is integrally connected with a second end of the edge part 31, a second end of the second feeder line 42 extends in the second direction D2, and an orthographic projection of the second feeder line 42 on the base substrate does not overlap with an orthographic projection of the second radiation patch 5 on the base substrate.

In an exemplary embodiment, thicknesses of the first feeder line 41 and the second feeder line 42 are both substantially equal to a thickness of the first radiation patch 3. For example, the thicknesses of the first feeder line 41 and the second feeder line 42 are both about 1 micron to 2 microns. Lengths of the first feeder line 41 and the second feeder line 42 in a first direction D1 are both approximately 0.5 mm to 1 mm and lengths of the first feeder line 41 and the second feeder line 42 in the second direction D2 are both approximately 5 mm to 10 mm. Herein, the first direction D1 and the second direction D2 are both parallel to a plane where the base substrate 2 is located, and the first direction D1 intersects with the second direction D2, for example, the first direction D1 is perpendicular to the second direction D2.

FIG. 1c is a top view of a second radiation patch of the antenna unit in FIG. 1a. In an exemplary embodiment, as shown in FIG. 1c, a shape of the second radiation patch 5 may be rectangular, and a thickness of the second radiation patch 5 may be approximately 0.5 millimeter to 3 millimeters, for example, 2 millimeters. The second radiation patch 5 is suspended on a side of the first radiation patch 3 away from the base substrate 2, a space is provided between the second radiation patch 5 and the first radiation patch 3, and the second radiation patch 5 is not in contact with the first radiation patch 3. The orthographic projection of the second radiation patch 5 on the base substrate 2 covers the orthographic projection of the first radiation patch 3 on the base substrate 2, and the orthographic projection of the second radiation patch 5 on the base substrate 2 overlaps with an orthographic projection of the feeder line 4 on the base substrate 2.

In an exemplary embodiment, a perpendicular distance between a surface on a side of the second radiation patch 5 close to the base substrate and a first surface of the base substrate 2 is 7.5 millimeters.

The antenna unit of an embodiment of the present disclosure may generate different resonance frequencies through the first radiation patch 3 and the second radiation patch 5, thereby achieving a purpose of broadening the bandwidth and enabling the antenna unit to achieve broadband.

In an exemplary embodiment, a support column is provided on the base substrate 2, the support column extends in the third direction D3, a first end of the support column is connected with a first surface of the base substrate 2, and a second end of the support column is connected with the second radiation patch 5. The support column is used to support the second radiation patch 5, so that the second radiation patch 5 may be suspended.

In an exemplary embodiment, an orthographic projection of the support column on the base substrate does not overlap with the orthographic projection of the first radiation patch 3 on the base substrate.

In an exemplary embodiment, a shape of the second radiation patch 5 may be rectangular, the second radiation patch 5 includes four corner parts, and the four corner part areas of the second radiation patch 5 are all provided with a second separation structure 72. A shape of the second separation structure 72 is a “U” shaped groove-like structure, and the second separation structure 72 is a groove body formed by a corner part of the second radiation patch 5 being recessed inside the second radiation patch 5.

Through the second separation structure on the second radiation patch, the antenna unit of an embodiment of the present disclosure may change a current path of the second radiation patch, extend an effective length of the current path, reduce a resonance frequency, thereby increasing an electrical length of the antenna unit, expanding a bandwidth of the antenna unit, and reducing a standing wave ratio of the antenna unit.

The antenna unit shown in FIG. 1a is simulated and tested. In the frequency band of 2.515 GHz to 2.675 GHz, the standing wave ratio VSWR of the antenna unit is ≤1.4. An isolation S12 between corresponding ports of a first feeder line and a second feeder line is ≤−17.78 dB. A realized gain total of the antenna unit is ≥7.83 dBi. A perpendicular plane wave width of the antenna unit is ≥66°. A horizontal plane wave width of the antenna unit is ≥70°. A cross-polarization ratio in an axial direction of the antenna unit is ≥24.34 dB. A cross-polarization ratio in ±600 of the antenna unit is ≥8.14 dB. A front-to-back ratio of the antenna unit is ≥15.08 dB.

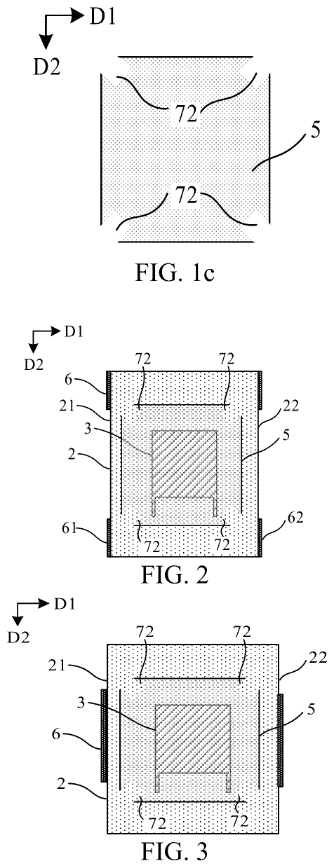

FIG. 2 is a top view of another antenna unit according to an exemplary embodiment of the present disclosure. The antenna unit of an exemplary embodiment of the present disclosure is substantially the same as the antenna unit shown in FIG. 1a, except that, as shown in FIG. 2, the base substrate 2 of the antenna unit of this embodiment is provided with a separation wall 6.

In the antenna unit of an embodiment of the present disclosure, through the separation wall on the base substrate, on one hand, an influence caused by a mutual coupling effect (also referred to as the coupling effect) between adjacent antenna units is reduced, and an isolation between adjacent antenna units is improved. On the other hand, the separation wall may increase the cross-polarization ratio in ±60° and the front-to-back ratio of the antenna unit.

In an exemplary embodiment, at least one separation wall 6 is provided on an edge part of the base substrate 2, and a shape of the separation wall 6 is rectangular. A first end of the separation wall 6 is connected with the edge part of the base substrate 2, and a second end of the separation wall 6 extends in a direction perpendicular to the base substrate 2, protruding from the first surface of the base substrate 2.

In an exemplary embodiment, the base substrate 2 includes a first edge 21 and a second edge 22 provided opposite to each other, and each of the first edge 21 and the second edge 22 extends in the second direction D2. The first edge 21 is provided with first separation walls 61 at two opposite ends in the second direction D2, two first separation walls 61 are disconnected from each other, and the two first separation walls 61 are both perpendicular to the first edge 21. Herein, a thickness of the first separation wall 61 is 0.2 millimeter to 1.5 millimeters, for example, 0.5 millimeter. The second edge 22 is provided with second separation walls 62 at two opposite ends in the second direction D2, two second separation walls 62 are disconnected from each other, and the two second separation walls 62 are both perpendicular to the second edge 22. Herein, a thickness of the second separation wall 62 is 0.2 millimeter to 1.5 millimeters, for example, 0.5 millimeter.

Taking the first radiation patch 3 with a size of 25 mm×25 mm, a perpendicular distance of 6.5 millimeters between a surface on a side of the second radiation patch 5 close to the base substrate and the first surface of the base substrate 2, and the separation wall 6 with a size of 21.875 mm×7.5 mm×0.5 mm as an example, the antenna unit shown in FIG. 2 is simulated and tested. In the frequency band of 2.515 Ghz to 2.675 GHz, the standing wave ratio VSWR of the antenna unit is ≤1.51. An isolation S12 between corresponding ports of a first feeder line and a second feeder line is ≤−18.1 dB. A realized gain total of the antenna unit is ≥7.57 dBi. A perpendicular plane wave width of the antenna unit is ≥69°. A horizontal plane wave width of the antenna unit is ≥73°. A cross-polarization ratio in an axial direction of the antenna unit is ≥20.81 dB. A cross-polarization ratio in ±60° of the antenna unit is ≥16.01 dB. A front-to-back ratio of the antenna unit is ≥23.71 dB.

From the above simulation results, it can be seen that the isolation between adjacent antenna units may be improved through the separation wall, and the cross-polarization ratio in 60° and the front-to-back ratio of the antenna units may be increased.

FIG. 3 is a top view of another antenna unit according to an exemplary embodiment of the present disclosure. The antenna unit of an exemplary embodiment of the present disclosure is substantially the same as the antenna unit shown in FIG. 1a, except that, as shown in FIG. 3, a base substrate 2 of the antenna unit of this embodiment is provided with a separation wall 6.

In an exemplary embodiment, a shape of the base substrate 2 is rectangular, the base substrate 2 includes a first edge 21 and a second edge 22 provided opposite to each other, and the first edge 21 and the second edge 22 both extend in the second direction D2. The separation wall 6 is provided in the middle of the first edge 21 and the second edge 22.

Taking the separation wall 6 with a size of 25 mm×3 mm×0.5 mm as an example, the antenna unit shown in FIG. 3 is simulated and tested. In the frequency band of 2.515 GHz to 2.675 GHz, the standing wave ratio VSWR of the antenna unit is ≤1.48. An isolation S12 between corresponding ports of a first feeder line and a second feeder line is ≤−19.31 dB. A realized gain total of the antenna unit is ≥7.82 dBi. A perpendicular plane wave width of the antenna unit is ≥66°. A horizontal plane wave width of the antenna unit is ≥70°. A cross-polarization ratio in an axial direction of the antenna unit is ≥25.37 dB. A cross-polarization ratio in ±60° of the antenna unit is ≥10.11 dB. A front-to-back ratio of the antenna unit is ≥15.49 dB.

From the above simulation results, it can be seen that the isolation between adjacent antenna units may be improved through the separation wall, and the cross-polarization ratio in 60° and the front-to-back ratio of the antenna units may be increased.

FIG. 4a is a top view of another antenna unit according to an exemplary embodiment of the present disclosure. The antenna unit of an exemplary embodiment of the present disclosure is substantially the same as the antenna unit shown in FIG. 1a, except that, as shown in FIG. 4a, two first separation structures 71 are provided on the first radiation patch 3 of the antenna unit of this embodiment. The two first separation structures 71 are located between the two feeder lines 4, and the two first separation structures 71 and the two feeder lines 4 are located on the same side of the first radiation patch 3.

FIG. 4b is a top view of a first radiation patch of the antenna unit in FIG. 4a. In an exemplary embodiment, as shown in FIG. 4b, the first radiation patch 3 includes an edge part 31 located on a side in the second direction D2, the edge part 31 extends in the first direction D1, and the edge part 31 is respectively connected to the feeder lines 4 at two ends in the first direction D1. Two first separation structures 71 are provided on the edge part 31, and the two first separation structures 71 are both located between the two feeder lines 4. Herein, the first direction D1 and the second direction D2 are both parallel to a plane where the display substrate is located, and the first direction D1 intersects with the second direction D2, for example, the first direction D1 is perpendicular to the second direction D2.

Through the first separation structure on the first radiation patch, the antenna unit of an embodiment of the present disclosure, on one hand, may change a current path of the first radiation patch, extend an effective length of the current path, and reduce a resonance frequency, thereby increasing an electrical length of the antenna unit, expanding a bandwidth of the antenna unit, and reducing a standing wave ratio of the antenna unit. On the other hand, the first separation structure may improve the isolation between the two feeder lines 4.

In an exemplary embodiment, a shape of the first separation structure 71 is a “U” shaped groove-like structure, and the first separation structure 71 is a groove body formed by recessing the edge part 31 in the opposite direction of the second direction D2.

In an exemplary embodiment, a ratio of a third length of the first separation structure 71 to a fourth length of the first separation structure is 1 to 4, the third length is a distance feature in the second direction D2, and the fourth length is a distance feature in the first direction D1. For example, the third length of the first separation structure 71 is 2 millimeters, and the fourth length of the first separation structure 71 is 0.5 millimeter.

In an exemplary embodiment, two first separation structures 71 on the edge part 31 are symmetrically provided on two sides of a central axis of the first radiation patch 3 in the second direction D2.

In an exemplary embodiment, the feeder line 4 includes a first feeder line 41 and a second feeder line 42, and both of the first feeder line 41 and the second feeder line 42 are connected to the edge part 31 of the first radiation patch 3.

In an exemplary embodiment, a distance between a central axis O of the first separation structure 71 located on a side of the edge part 31 close to the first feeder line 41 and an edge of the first feeder line 41 is L1, a distance between the central axis O of the first separation structure 71 located on the side of the edge part 31 close to the first feeder line 41 and an edge of the second feeder line 42 is L2, and a ratio of L2 to L1 is 3 to 4. For example, L1 is 5.25 millimeters.

The antenna unit shown in FIG. 4a is simulated and tested. In the frequency band of 2.515 GHz to 2.675 GHz, the standing wave ratio VSWR of the antenna unit is ≤1.32. An isolation S12 between corresponding ports of a first feeder line and a second feeder line is ≤−21.99 dB. A realized gain total of the antenna unit is ≥7.8 dBi. A perpendicular plane wave width of the antenna unit is ≥66°. A horizontal plane wave width of the antenna unit is ≥70°. A cross-polarization ratio in an axial direction of the antenna unit is ≥33.6 dB. A cross-polarization ratio in ±600 of the antenna unit is ≥8.91 dB. A front-to-back ratio of the antenna unit is ≥15.31 dB.

From the above simulation results, it can be seen that by the first separation structure, the standing wave ratio of the antenna may be reduced, and the isolation between the first feeder line and the second feeder line may be improved.

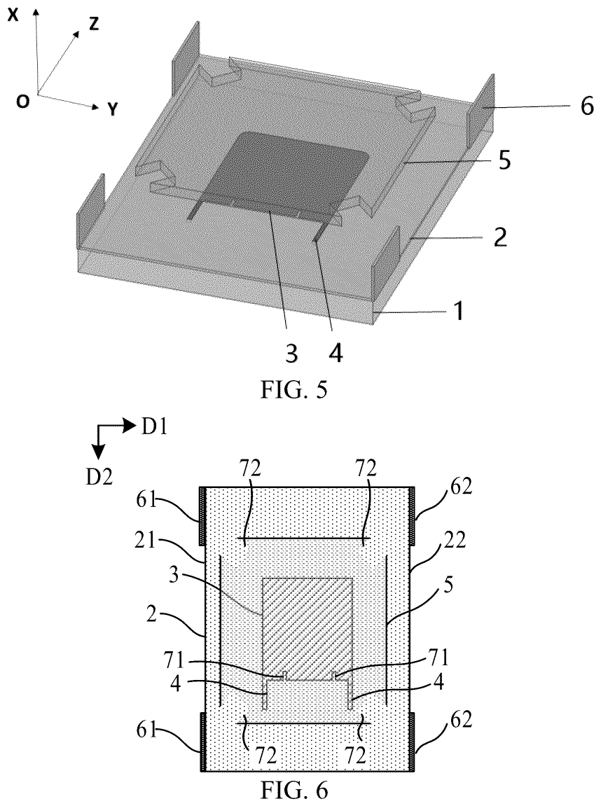

FIG. 5 is a schematic structural diagram of another antenna unit according to an exemplary embodiment of the present disclosure. In an exemplary embodiment, as shown in FIG. 5, the antenna unit includes a reflection plate 1, a base substrate 2, a first radiation patch 3, a feeder line 4, and a second radiation patch 5.

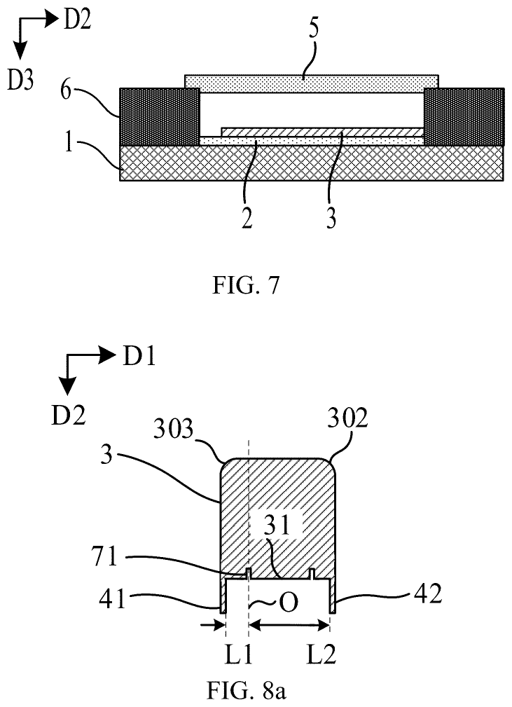

FIG. 6 is a top view of the antenna unit in FIG. 5 and FIG. 7 is a side view of the antenna unit in FIG. 5. In an exemplary embodiment, as shown in FIGS. 6 and 7, a shape of the base substrate 2 may be rectangular. The base substrate 2 includes a first surface and a second surface provided opposite to each other in a thickness direction of the base substrate, the first surface is a surface of the base substrate 2 on a side in an opposite direction of the third direction D3, and the second surface is a surface of the base substrate 2 on a side in the third direction D3. The first radiation patch 3 and the feeder line 4 are provided on the first surface of the base substrate 2 and the first surface of the base substrate 2 is in contact with the first radiation patch 3 and the feeder line 4. The reflection plate 1 is provided on the second surface of the base substrate 2 and the second surface of the base substrate 2 is in contact with the reflection plate 1. Herein, the third direction D3 intersects with a plane where the base substrate 2 is located, and for example, the third direction D3 is perpendicular to the plane where the base substrate 2 is located.

In an exemplary embodiment, the first radiation patch 3 and the feeder line 4 may be formed on the first surface of the base substrate 2 by a vapor deposition process, and the reflection plate 1 may be obtained on the second surface of the base substrate 2 by a metal integrated molding process.

In an exemplary embodiment, the base substrate 2 is a glass base substrate. For example, a dielectric constant of the glass base substrate is 5.5, a dielectric loss angle tangent of the glass base substrate is 0.004, and a thickness of the glass base substrate is 0.5 mm.

The antenna unit of an embodiment of the present disclosure adopts the glass base substrate, which effectively reduces a weight and cost of the antenna unit compared with a metal vibrator (sheet metal/die-casting), and may realize an integration of more antenna units. For example, a quantity of antenna units is 192, 256 or 384, and the glass base substrate may effectively reduce a weight and cost of the antenna units.

In an exemplary embodiment, the antenna unit of an embodiment of the present disclosure may be integrated into a 5G base station to achieve a purpose of energy saving and cost reduction.

In an exemplary embodiment, a shape of the reflection plate 1 may be rectangular. A surface of the reflection plate 1 is in contact with a second surface of the base substrate 2. The reflection plate 1 may be configured to reflect the signal emitted by the first radiation patch 3 in a direction towards the second radiation patch 5, thereby improving signal strength of the antenna unit.

In an exemplary embodiment, the reflection plate 1 is made of a conductive material, and the reflection plate 1 is grounded.

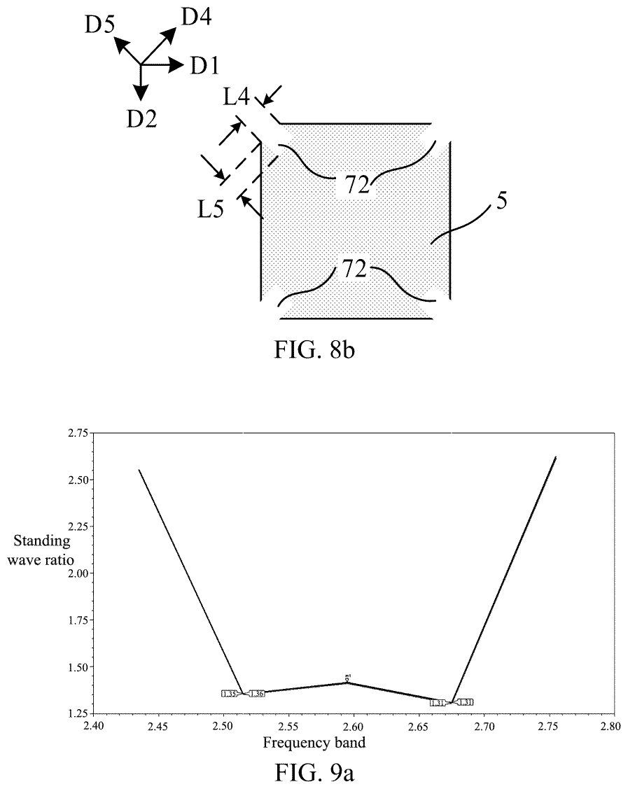

FIG. 8a is a top view of a first radiation patch of the antenna unit in FIG. 5. In an exemplary embodiment, as shown in FIG. 8a, a shape of the first radiation patch 3 may be rectangular, and a thickness of the first radiation patch 3 may be approximately 1 micron to 2 microns, for example, 1.2 microns. A surface of the first radiation patch 3 is in contact with the first surface of the base substrate 2. An orthographic projection of the first radiation patch 3 on the base substrate 2 is located within an orthographic projection of the second radiation patch 5 on the base substrate 2. The first radiation patch 3 is electrically connected to the feeder line 4 and the first radiation patch 3 may emit a signal through an excitation signal applied by the feeder line 4.

In an exemplary embodiment, the first radiation patch 3 includes an edge part 31 located on a side in the second direction D2, the edge part 31 extends in the first direction D1, and the edge part 31 is connected to the feeder lines 4 at two ends respectively in the first direction D1. Two first separation structures 71 are provided on the edge part 31, and the two first separation structures 71 are both located between the two feeder lines 4. Herein, the first direction D1 and the second direction D2 are both parallel to the plane where the display substrate 2 is located, and the first direction D1 intersects with the second direction D2, for example, the first direction D1 is perpendicular to the second direction D2.

Through the first separation structure on the first radiation patch, the antenna unit of an embodiment of the present disclosure, on one hand, may change a current path of the first radiation patch, extend an effective length of the current path, and reduce a resonance frequency, thereby increasing an electrical length of the antenna unit, expanding a bandwidth of the antenna unit, and reducing a standing wave ratio of the antenna unit. On the other hand, the first separation structure may improve the isolation between the two feeder lines 4.

In an exemplary embodiment, a shape of the first separation structure 71 is a “U” shaped groove-like structure, and the first separation structure 71 is a groove body formed by recessing the edge part 31 in the opposite direction of the second direction D2.

In an exemplary embodiment, a ratio of a third length of the first separation structure 71 to a fourth length of the first separation structure is 1 to 4, the third length is a distance feature in the second direction D2, and the fourth length is a distance feature in the first direction D1. For example, the third length of the first separation structure 71 is 2 millimeters, and the fourth length of the first separation structure 71 is 0.5 millimeter.

In an exemplary embodiment, two first separation structures 71 on the edge part 31 are symmetrically provided on two sides of a central axis of the first radiation patch 3 in the second direction D2.

In an exemplary embodiment, a shape of the first radiation patch 3 includes a rectangle, and at least one corner part of the first radiation patch 3 is a rounded corner. For example, the first radiation patch 3 includes a first corner part 302 and a second corner part 303 located on a side in an opposite direction of the second direction D2, and both of the first corner part 302 and the second corner part 303 may be rounded corners, as shown in FIG. 8.

In an exemplary embodiment, the feeder line 4 includes a first feeder line 41 and a second feeder line 42, and both of the first feeder line 41 and the second feeder line 42 are connected to the edge part 31 of the first radiation patch 3.

In the antenna unit of an embodiment of the present disclosure, the antenna unit is excited through the first feeder line and the second feeder line, each radiating to generate polarization of ±45°.

In an exemplary embodiment, a first end of the first feeder line 41 is integrally connected with a first end of the edge part 31, a second end of the first feeder line 41 extends in a second direction D2, and an orthographic projection of the first feeder line 41 on the base substrate does not overlap with an orthographic projection of the second radiation patch 5 on the base substrate. Herein, being integrally connected refers to being prepared by using the same material through the same preparation process.

In an exemplary embodiment, a first end of the second feeder line 42 is integrally connected with a second end of the edge part 31, a second end of the second feeder line 42 extends in the second direction D2, and an orthographic projection of the second feeder line 42 on the base substrate does not overlap with an orthographic projection of the second radiation patch 5 on the base substrate.

In an exemplary embodiment, thicknesses of the first feeder line 41 and the second feeder line 42 are both substantially equal to a thickness of the first radiation patch 3. For example, the thicknesses of the first feeder line 41 and the second feeder line 42 are both approximately 1 micron to 2 microns. Lengths of the first feeder line 41 and the second feeder line 42 in the first direction D1 are both approximately 0.5 millimeter to 1 millimeter and lengths of the first feeder line 41 and the second feeder line 42 in the second direction D2 are both approximately 5 millimeters to 10 millimeters.

In an exemplary embodiment, a distance between a central axis O of the first separation structure 71 located on a side of the edge part 31 close to the first feeder line 41 and an edge of the first feeder line 41 is L1, a distance between the central axis O of the first separation structure 71 located on the side of the edge part 31 close to the first feeder line 41 and an edge of the second feeder line 42 is L2, and a ratio of L2 to L1 is 3 to 4. For example, L1 is 5.25 millimeters.

In an exemplary embodiment, at least one separation wall 6 is provided on an edge part of the base substrate 2, and a shape of the separation wall 6 is rectangular. A first end of the separation wall 6 is connected with the edge part of the base substrate 2, and a second end of the separation wall 6 extends in the third direction D3, protruding from the first surface of the base substrate 2.

In the antenna unit of an embodiment of the present disclosure, through the separation wall on the base substrate, on one hand, an influence caused by a mutual coupling effect (also referred to as the coupling effect) between adjacent antenna units is reduced, and an isolation between adjacent antenna units is improved. On the other hand, the separation wall may increase the cross-polarization ratio in ±60° and the front-to-back ratio of the antenna unit.

In an exemplary embodiment, the base substrate 2 includes a first edge 21 and a second edge 22 provided opposite to each other, and each of the first edge 21 and the second edge 22 extends in the second direction D2. The first edge 21 is provided with first separation walls 61 at two opposite ends in the second direction D2, two first separation walls 61 are disconnected from each other, and the two first separation walls 61 are both perpendicular to the first edge 21. Herein, a thickness of the first separation wall 61 is 0.2 millimeter to 1.5 millimeters, for example, 0.5 millimeter. The second edge 22 is provided with second separation walls 62 at two opposite ends in the second direction D2, two second separation walls 62 are disconnected from each other, and the two second separation walls 62 are both perpendicular to the second edge 22. Herein, a thickness of the second separation wall 62 is 0.2 millimeter to 1.5 millimeters, for example, 0.5 millimeter.

In an exemplary embodiment, the reflection plate 1, the first radiation patch 3, the feeder line 4, and the second radiation patch 5 may all be made of metal materials. For example, the reflection plate 1, the first radiation patch 3, the feeder line 4, and the second radiation patch 5 may all include, but are not limited to, metal such as copper, aluminum, or an alloy, so that the reflection plate 1, the first radiation patch 3, the feeder line 4, and the second radiation patch 5 have low resistance and high sensitivity of transmission signal.

In some embodiments, the reflection plate 1, the base substrate 2, the first radiation patch 3, the feeder line 4, and the second radiation patch 5 may also adopt other shapes. For example, the shapes of the reflection plate 1, the base substrate 2, the first radiation patch 3, the feeder line 4, and the second radiation patch 5 may include, but are not limited to, one of a circle, a triangle, a sector, and the like.

FIG. 8b is a top view of a second radiation patch of the antenna unit in FIG. 5. In an exemplary embodiment, as shown in FIG. 8b, a shape of the second radiation patch 5 may be rectangular, and a thickness of the second radiation patch 5 may be approximately 0.5 millimeter to 3 millimeters, for example, 2 millimeters. The second radiation patch 5 is suspended on a side of the first radiation patch 3 away from the base substrate 2, a space is provided between the second radiation patch 5 and the first radiation patch 3, and the second radiation patch 5 is not in contact with the first radiation patch 3. An orthographic projection of the second radiation patch 5 on the base substrate 2 covers an orthographic projection of the first radiation patch 3 on the base substrate 2.

The antenna unit of an embodiment of the present disclosure may generate different resonance frequencies through the first radiation patch 3 and the second radiation patch 5, thereby achieving a purpose of broadening the bandwidth, so that the antenna unit may achieve broadband.

In an exemplary embodiment, a support column is provided on the base substrate 2, the support column extends in the third direction D3, a first end of the support column is connected with a first surface of the base substrate 2, and a second end of the support column is connected with the second radiation patch 5. The support column is used to support the second radiation patch 5, so that the second radiation patch 5 may be suspended.

In an exemplary embodiment, a perpendicular distance between a surface on a side of the second radiation patch 5 close to the base substrate and a first surface of the base substrate 2 is 6.5 millimeters.

In an exemplary embodiment, an orthographic projection of the support column on the base substrate does not overlap with the orthographic projection of the first radiation patch 3 on the base substrate.

In an exemplary embodiment, a shape of the second radiation patch 5 may be rectangular, the second radiation patch 5 includes four corner parts, and the four corner part areas of the second radiation patch 5 are all provided with a second separation structure 72. A shape of the second separation structure 72 is a “U” shaped groove-like structure, and the second separation structure 72 is a groove body formed by a corner part of the second radiation patch 5 being recessed inside the second radiation patch 5.

Through the second separation structure on the second radiation patch, the antenna unit of an embodiment of the present disclosure may change a current path of the second radiation patch, extend an effective length of the current path, and reduce a resonance frequency, thereby increasing an electrical length of the antenna unit, expanding a bandwidth of the antenna unit, and reducing a standing wave ratio of the antenna unit.

In an exemplary embodiment, a ratio between a first length L4 of the second separation structure 72 and a second length L5 of the second separation structure 72 is 0.5 to 2, for example, the first length L4 is 6 millimeters and the second length L5 is 5 millimeters. Herein, the first length L4 is a distance feature in a fourth direction D4, the second length L5 is a distance feature in a fifth direction D5, the fourth direction D4 and the fifth direction D5 are both parallel to the base substrate, and the fourth direction D4 intersects with the fifth direction D5. For example, the fourth direction D4 is perpendicular to the fifth direction D5.

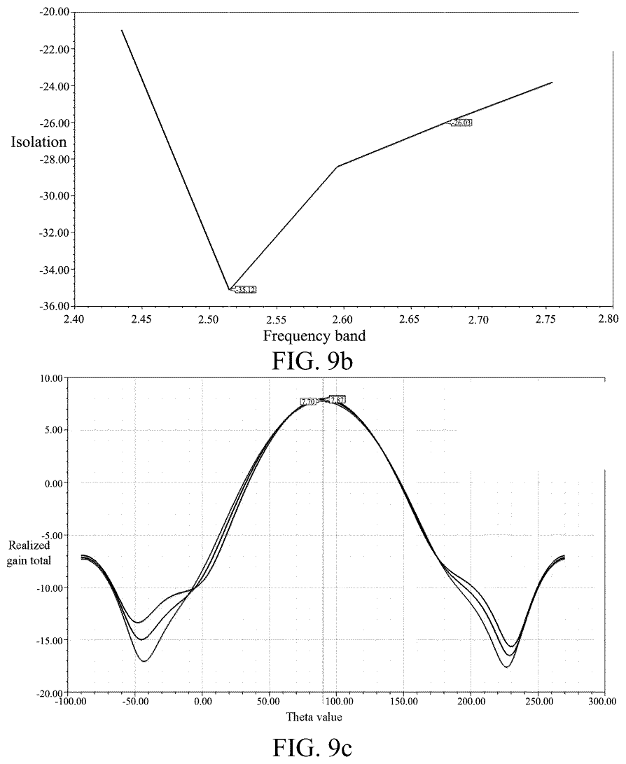

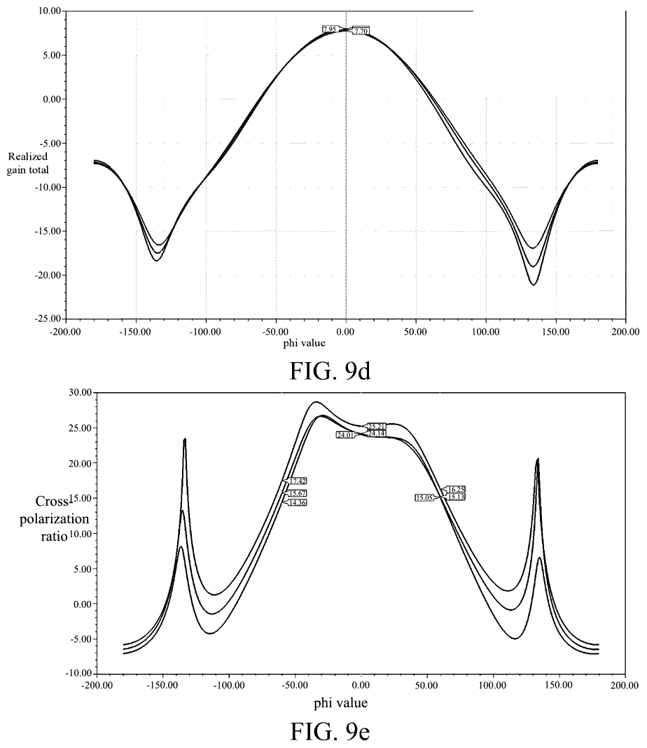

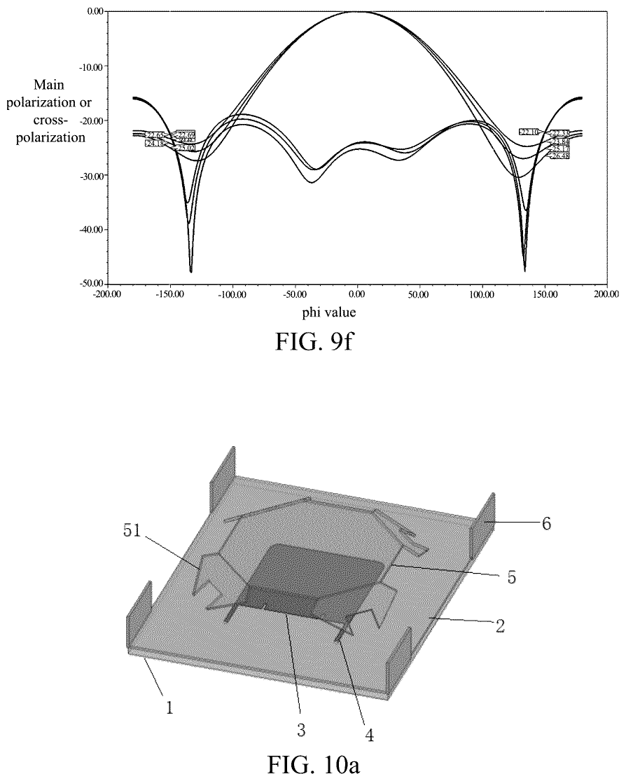

FIG. 9f shows the simulation results of the antenna unit shown in FIG. 5. Taking the following as an example: a size of the base substrate is 68.75 mm×56.25 mm, a size of the first radiation patch is 24.7 mm×24.7 mm, sizes of the first feeder line and the second feeder line are both 7 mm×0.82 mm, a size of the second radiation patch is 45 mm×45 mm, a distance between the second radiation patch and the first surface of the base substrate is 6.5 mm, a size of the separation wall is 14.375 mm×7.5 mm, a size of the first separation structure on the first radiation patch is 2 mm×0.5 mm, a size of the second separation structure on the second radiation patch is 6 mm×5 mm, and the error of the above dimensions is ±0.2 mm to ±0.5 mm, the specific explanation is as follows.

FIG. 9a is a graph of a standing wave ratio of corresponding ports of a first feeder line and a second feeder line of the antenna unit in FIG. 5. An abscissa of FIG. 9a is a frequency band and an ordinate of FIG. 9a is a standing wave ratio of corresponding ports of the first feeder line and the second feeder line. As shown in FIG. 9a, in the frequency band of 2.515 GHz to 2.675 GHz, the standing wave ratio VSWR of the corresponding ports of the first feeder line and the second feeder line of the antenna unit is ≤1.42.

FIG. 9b is a graph of an isolation between corresponding ports of a first feeder line and a second feeder line of the antenna unit in FIG. 5. An abscissa of FIG. 9b is a frequency band and an ordinate of FIG. 9b is an isolation between corresponding ports of the first feeder line and the second feeder line. As shown in FIG. 9b, in the frequency band of 2.515 GHz to 2.675 GHz, the isolation S12 between the corresponding ports of the first feeder line and the second feeder line of the antenna unit is ≤−26.03 dB.

FIG. 9c is a graph of a perpendicular plane gain and a wave width of a single port excitation of the antenna unit in FIG. 5 and the perpendicular plane is an XOZ plane in a radiation coordinate system in FIG. 5. An abscissa of FIG. 9c is a theta value, theta is an included angle with the Z axis in the radiation coordinate system in FIG. 5, and an ordinate of FIG. 9c is a realized gain total of the antenna unit. As shown in FIG. 9c, in the frequency band of 2.515 GHz to 2.675 GHz, the realized gain total of the antenna unit is ≥7.7 dBi, and the perpendicular plane wave width of the antenna unit is ≥68°.

FIG. 9d is a graph of a horizontal plane gain and a wave width of a single port excitation of the antenna unit in FIG. 5 and the horizontal plane is an XOY plane in a radiation coordinate system in FIG. 5. An abscissa of FIG. 9d is a phi value, phi is an included angle with the X axis in the radiation coordinate system in FIG. 5, and an ordinate of FIG. 9d is a realized gain total of the antenna unit. As shown in FIG. 9d, in the frequency band of 2.515 GHz to 2.675 GHz, the realized gain total of the antenna unit is ≤7.7 dBi, and the horizontal plane wave width is ≤72°.

FIG. 9e is a graph of a cross-polarization ratio of a single port excitation of the antenna unit in FIG. 5 and the cross-polarization ratio is a difference between a main polarization and a cross-polarization. An abscissa of FIG. 9d is a phi value and an ordinate of FIG. 9d is a cross-polarization ratio. As shown in FIG. 9e, in the frequency band of 2.515 GHz to 2.675 GHz, the cross-polarization ratio in an axial direction of the antenna unit is ≥24.01 dB, and the cross-polarization ratio in ±60° of the antenna unit is ≥14.36 dB.

FIG. 9f is a graph of a front-to-back ratio of a single port excitation of the antenna unit in FIG. 5. An abscissa of FIG. 9f is a phi value and an ordinate of FIG. 9f is a main polarization or cross-polarization of the antenna unit. The front-to-back ratio is 180° in an opposite direction of a normal direction of the antenna unit and the worst value of the main polarization and the cross-polarization within a range of 180°±30° is taken. As shown in FIG. 9f, in the frequency band of 2.515 GHz to 2.675 GHz, the front-to-back ratio of the antenna unit is ≥22.1 dB.

From the above simulation results, it can be seen that the antenna unit of an embodiment of the present disclosure may improve a standing wave characteristics of the antenna unit and an isolation between the feeder lines through the first separation structure and the second separation structure. Additionally, the separation wall may increase the cross-polarization ratio in ±60° and the front-to-back ratio of the antenna unit and reduce the mutual coupling between adjacent antenna unit sets.

In some embodiments, a thickness of the second radiation patch may be reduced, an area of the orthographic projection of the second radiation patch on the base substrate may be increased, and a weight of the second radiation patch may be reduced while ensuring impedance matching of the antenna unit, thereby reducing the weight of the antenna unit. For example, a size of the second radiation patch is adjusted from 45 mm×45 mm×2 mm to 46.5 mm×46.5 mm×0.5 mm, and an orthographic projection of the feeder line on the base substrate is located within an orthographic projection of the second radiation patch on the base substrate, thereby reducing the weight of the second radiation patch.

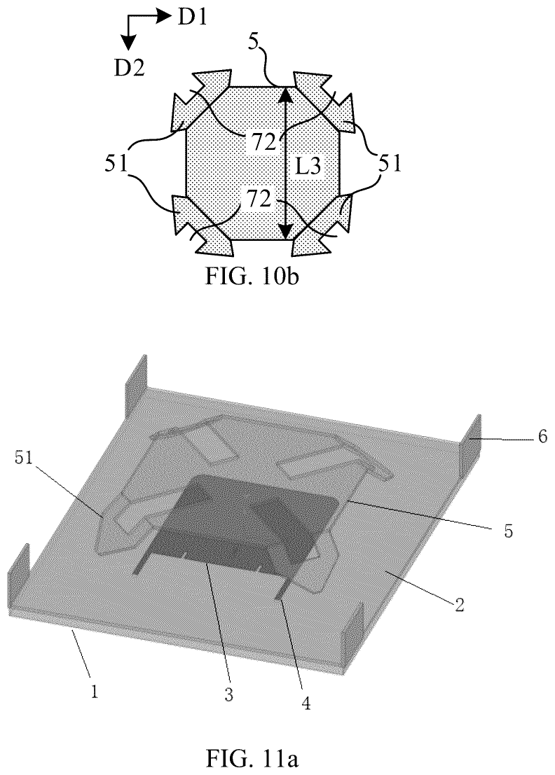

FIG. 10a is a schematic structural diagram of another antenna unit according to an exemplary embodiment of the present disclosure. The antenna unit of an exemplary embodiment of the present disclosure is substantially the same as the antenna unit shown in FIG. 5, except that, as shown in FIG. 10a, at least one protrusion part 51 is provided on the second radiation patch 5 of the antenna unit of this embodiment. The protrusion part 51 is curved in a direction towards the base substrate 2 and is inclined relative to the second radiation patch 5, and the second separation structure 72 is provided on the protrusion part 51. A shape of the second separation structure 72 is a “U” shaped groove-like structure, and the second separation structure 72 is curved in the direction towards to the base substrate 2 following the protrusion part 51, and is inclined relative to the second radiation patch 5.

FIG. 10b is a schematic structural diagram of a second radiation patch of the antenna unit in FIG. 10a. In an exemplary embodiment, as shown in FIGS. 10a and 10b, a shape of the second radiation patch 5 is octagonal, and the second radiation patch 5 includes four first edge parts and four second edge parts. The first edge parts and the second edge parts are arranged to overlap in a circumferential direction of the second radiation patch, and a second edge part is provided between adjacent first edge parts. The protrusion parts 51 are respectively provided on the four first edge parts, a shape of the protrusion parts 51 is pentagonal, and the protrusion parts 51 include corner parts located on a side away from the first edge parts. The second separation structures 72 are provided in corner part areas of the protrusion parts 51, and the second separation structure 72 is curved in the direction towards the base substrate 2 following the protrusion part 51, and is inclined relative to the second radiation patch 5.

Taking a length L3 of the second radiation patch 5 in the second direction D2 being 35 mm as an example, the antenna unit is simulated and tested. In the frequency band of 2.515 GHz to 2.675 GHz, the standing wave ratio VSWR of the antenna unit is ≤1.45. An isolation S12 between corresponding ports of a first feeder line and a second feeder line is ≤−27.10 dB. A realized gain total of the antenna unit is ≥7.11 dBi. A perpendicular plane wave width of the antenna unit is ≥73°. A horizontal plane wave width of the antenna unit is ≥78°. A cross-polarization ratio in an axial direction of the antenna unit is ≥21.81 dB. A cross-polarization ratio in ±60° of the antenna unit is ≥19.18 dB. A front-to-back ratio of the antenna unit is ≥22.28 dB.

In some embodiments, the second radiation patch may also be another polygon, for example, a pentagon, a hexagon, a heptagon, a decagon, or the like.

FIG. 11a is a schematic structural diagram of another antenna unit according to an exemplary embodiment of the present disclosure. The antenna unit of an exemplary embodiment of the present disclosure is substantially the same as the antenna unit shown in FIG. 5, except that, as shown in FIG. 11a, at least one protrusion part 51 is provided on the second radiation patch 5 of the antenna unit of this embodiment. The protrusion part 51 is inclined in a direction towards the base substrate 2 and is inclined relative to the second radiation patch 5, a second separation structure 72 is provided on the protrusion part 51, and a shape of the second separation structure 72 is a rectangular through-hole structure.

FIG. 11b is a schematic structural diagram of a second radiation patch of the antenna unit in FIG. 11a. In an exemplary embodiment, as shown in FIGS. 11a and 11b, a shape of the second radiation patch 5 is octagonal, and the second radiation patch 5 includes four first edge parts and four second edge parts. The first edge parts and the second edge parts are arranged to overlap in a circumferential direction of the second radiation patch, and a second edge part is provided between adjacent first edge parts. The protrusion parts 51 are respectively provided on four first edge parts, a shape of the protrusion part 51 is pentagonal, and the second separation structure 72 includes a first end, a middle portion and a second end connected sequentially. The first end of the second separation structure 72 is provided on the protrusion part 51, the first end of the second separation structure 72 is inclined in the direction towards the base substrate 2 following the protrusion part 51, and the middle portion and the second end of the second separation structure 72 are provided on the second radiation patch 5.

Taking a length L3 of the second radiation patch 5 in the second direction D2 being 35 mm as an example, the antenna unit is simulated and tested. In the frequency band of 2.515 GHz to 2.675 GHz, the standing wave ratio VSWR of the antenna unit is ≤1.39. An isolation S12 between corresponding ports of a first feeder line and a second feeder line is ≤−28.5 dB. A realized gain total of the antenna unit is ≥7.26 dBi. A perpendicular plane wave width of the antenna unit is ≥77°. A horizontal plane wave width of the antenna unit is ≥77°. A cross-polarization ratio in an axial direction of the antenna unit is ≥23.21 dB. A cross-polarization ratio in ±600 of the antenna unit is ≥17.05 dB. A front-to-back ratio of the antenna unit is ≥21.73 dB.

A method for preparing an antenna unit is also provided in an embodiment of the present disclosure. The method includes: forming a first radiation patch and a feeder line on a base substrate, the feeder line being connected to the first radiation patch; and forming a second radiation patch on a side of the first radiation patch away from the base substrate. The second radiation patch is suspended on the first radiation patch, an orthographic projection of the second radiation patch on the base substrate overlaps with an orthographic projection of the first radiation patch on the base substrate, and the second radiation patch is provided with at least one second separation structure.

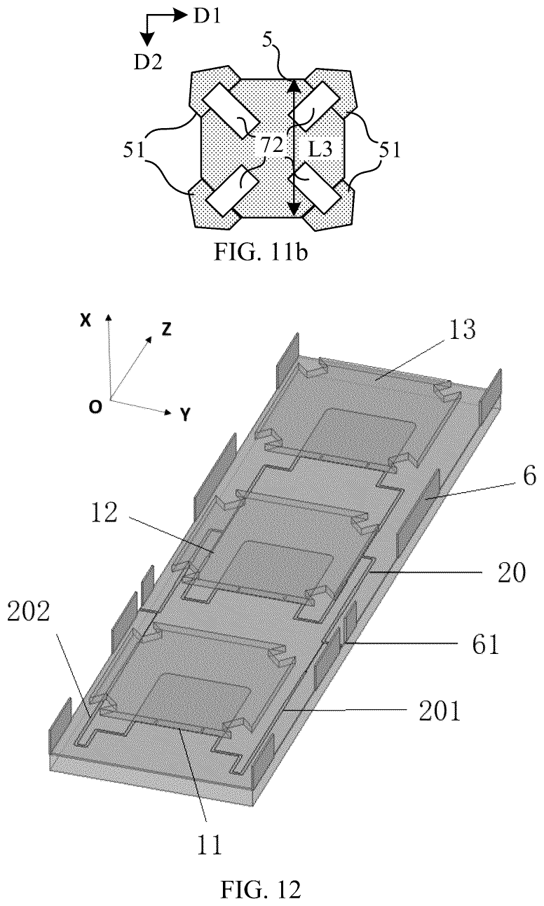

FIG. 12 is a schematic structural diagram of an antenna array according to an exemplary embodiment of the present disclosure. FIG. 12 illustrates an antenna array including three antenna units. In some embodiments, the antenna array may include other quantities of antenna units, for example 1, 2, 4, and the like.

In an exemplary embodiment, as shown in FIG. 12, the antenna array of an exemplary embodiment of the present disclosure includes a first antenna unit 11, a second antenna unit 12, a third antenna unit 13, and a power divider circuit 20, and the first antenna unit 11, the second antenna unit 12, and the third antenna unit 13 are sequentially arranged in the second direction D2 to form an antenna unit row. The power divider circuit 20 includes a first one-to-three-equal power division circuit 201 and a second one-to-three-equal power division circuit 202 and the first one-to-three-equal power division circuit 201 and the second one-to-three-equal power division circuit 202 are respectively located on two opposite sides of the antenna unit row. The first one-to-three-equal power division circuit 201 is electrically connected to the first feeder lines of the first antenna unit 11, the second antenna unit 12, and the third antenna unit 13, respectively, and the second one-to-three-equal power division circuit 202 is electrically connected to the second feeder lines of the first antenna unit 11, the second antenna unit 12, and the third antenna unit 13, respectively. The power divider circuit 20 is configured to provide a signal of substantially equal power to each antenna unit in the antenna unit row. Herein, the power divider circuit 20 forms a 1-to-3 antenna array with the first antenna unit 11, the second antenna unit 12, and the third antenna unit 13.

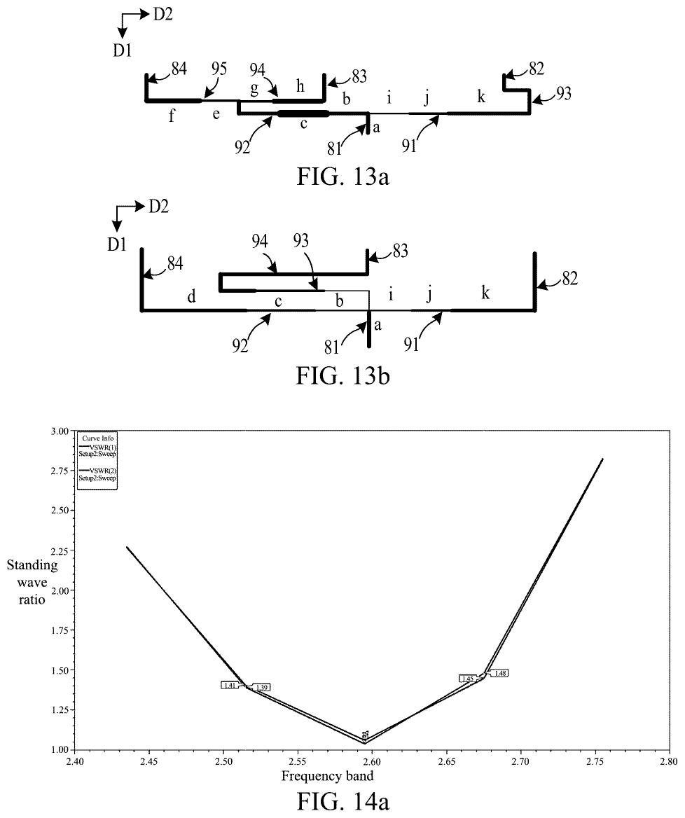

FIG. 13a is a first schematic structural diagram of a one-to-three-equal power division circuit of an antenna array according to an exemplary embodiment of the present disclosure. In an exemplary embodiment, as shown in FIG. 13a, the one-to-three-equal power division circuit is a two-stage power division circuit. The one-to-three-equal power division circuit includes a main line 81, a first connection line 91, a second connection line 92, a third connection line 93, a fourth connection line 94, a fifth connection line 95, a first branch line 82, a second branch line 83, and a third branch line 84.

In an exemplary embodiment, a main body structure of the main line 81 extends in the first direction D1, a first end of the main line 81 is connected to both of the first ends of the first connection line 91 and the second connection line 92, and a second end of the main line 81 extends in the first direction D1.

In an exemplary embodiment, the first connection line 91 extends in the second direction D2, the first end of the first connection line 91 is connected to the first end of the main line 81, and a second end of the first connection line 91 extends in the second direction D2 and is connected to a first end of the third connection line 93.

In an exemplary embodiment, a shape of the third connection line 93 is L-shaped, the first end of the third connection line 93 is connected to the second end of the first connection line 91, and a second end of the third connection line 93 is connected to a first end of the first branch line 82.

In an exemplary embodiment, the first branch line 82 extends in the first direction D1, the first end of the first branch line 82 is connected to the second end of the third connection line 93, and a second end of the first branch line 82 extends in an opposite direction of the first direction D1 and is connected to a first feeder line of the third antenna unit 13.

In an exemplary embodiment, a shape of the second connection line 92 is L-shaped, the first end of the second connection line 92 is connected to the first end of the main line 81, and a second end of the second connection line 92 is connected to a first end of the fourth connection line 94 and a first end of the fifth connection line 95, respectively.

In an exemplary embodiment, the fourth connection line 94 extends in the second direction D2, the first end of the fourth connection line 94 is connected to the second end of the second connection line 92, and a second end of the fourth connection line 94 extends in the second direction D2 and is connected to a first end of the second branch line 83.

In an exemplary embodiment, the second branch line 83 extends in the first direction D1, the first end of the second branch line 83 is connected to the second end of the fourth connection line 94, and a second end of the second branch line 83 extends in the opposite direction of the first direction D1 and is connected to the first feeder line of the second antenna unit 12.

In an exemplary embodiment, the fifth connection line 95 extends in the second direction D2, the first end of the fifth connection line 95 is connected to the second end of the second connection line 92, and a second end of the fifth connection line 95 extends in the opposite direction of the second direction D2 and is connected to a first end of the third branch line 84.

In an exemplary embodiment, the third branch line 84 extends in the first direction D1, the first end of the third branch line 84 is connected to the second end of the fifth connection line 95, and a second end of the third branch line 84 extends in the opposite direction of the first direction D1 and is connected to a first feeder line of the first antenna unit 11.

In an exemplary embodiment, the first connection line 91 includes a first connection segment i, a second connection segment j, and a third connection segment k connected sequentially. A first end of the first connection segment i is connected to the main line 81, a second end of the first connection segment i is connected to a first end of the second connection segment j, and a second end of the second connection segment j is connected to the third connection segment k.

In an exemplary embodiment, the second connection line 92 includes a fourth connection segment b, a fifth connection segment c, and a sixth connection segment d connected sequentially. A first end of the fourth connection segment b is connected to the main line 81, a second end of the fourth connection segment b is connected to a first end of the fifth connection segment c, and a second end of the fifth connection segment c is connected to the sixth connection segment d.

In an exemplary embodiment, a power of the first connection line 91 is P1, a power of the second connection line 92 is P2, and P1:P2=1:2. An impedance of the main line 81 is Zₐ, an impedance of the first connection segment i is Zᵢ, an impedance of the second connection segment j is Zⱼ, an impedance of the fourth connection segment b is Z_{b}, an impedance of the fifth connection segment c is Z_{c}. Herein,

$${Z}_{i} = {Z}_{a} \sqrt{\frac{1 + {k}^{2}}{{k}^{3}}} , {Z}_{b} = {Z}_{a} \sqrt{k ( 1 + {k}^{2} )} , {Z}_{j} = \frac{{Z}_{a}}{\sqrt{k}} , {Z}_{c} = \sqrt{k} {Z}_{a} .$$

Herein, k²=0.5.

In an exemplary embodiment, the fourth connection line 94 includes a seventh connection segment g and an eighth connection segment h connected sequentially. A first end of the seventh connection segment g is connected to the second end of the second connection line 92, a second end of the seventh connection segment g is connected to a first end of the eighth connection segment h, and a second end of the eighth connection segment h is connected to the second branch line 83.

In an exemplary embodiment, the fifth connection line 95 includes a ninth connection segment e and a tenth connection segment f connected sequentially. A first end of the ninth connection segment e is connected to the second end of the second connection line 92, a second end of the ninth connection segment e is connected to a first end of the tenth connection segment f, and a second end of the tenth connection segment f is connected to the first branch line 81.

In an exemplary embodiment, an impedance of the ninth connection segment e is Zₑ, and an impedance of the tenth connection segment f is Z_{f}, Zₑ=\sqrt{2Z_{d}Z_{f}}.

In an exemplary embodiment, an impedance of the seventh connection segment g is Z_{g}, and an impedance of the eighth connection segment h is Zₕ, Z_{g}=\sqrt{2Z_{d}Zₕ}.

In an exemplary embodiment, an impedance Zₐ of the main line 81 is 50Ω, an impedance Zᵢ of the first connection segment i is 103Ω, an impedance Zⱼ of the second connection segment j is 59.5Ω, an impedance Zₖ of the third connection segment k is 50Ω, an impedance Z_{b} of the fourth connection segment b is 51.6Ω, an impedance Z_{c} of the fifth connection segment c is 42.1Ω, an impedance Z_{d} of the sixth connection segment d is 50Ω, an impedance Z_{g} of the seventh connection segment g is 70.7Ω, an impedance Zₕ of the eighth connection segment h is 70.7Ω, an impedance Zₑ of the ninth connection segment e is 70.7Ω, and an impedance Z_{f} of the tenth connection segment f is 50Ω.

In an exemplary embodiment, lengths of the fourth connection segment b, the fifth connection segment c, the ninth connection segment e, the seventh connection segment g, the first connection segment i, and the second connection segment j is ^{˜}λ/4.

The simulation test of the antenna array shown in FIG. 12 shows that when a thickness of the one-to-three-equal power division circuit is 1.2 μm, a standing wave ratio VSWR of the antenna array is <1.07, and an insertion loss of the antenna array is 0.36 dB to 0.84 dB, and when a thickness of the one-to-three-equal power division circuit is 12 μm, an insertion loss of the antenna array is 0.19 dB to 0.47 dB.

FIG. 13b is a second schematic structural diagram of a one-to-three-equal power division circuit of an antenna array according to an exemplary embodiment of the present disclosure. In an exemplary embodiment, as shown in FIG. 13b, the one-to-three-equal power division circuit is a one-stage power division circuit. The one-to-three-equal power division circuit includes a main line 81, a first connection line 91, a second connection line 92, a third connection line 93, a fourth connection line 94, a first branch line 82, a second branch line 83, and a third branch line 84.

In an exemplary embodiment, a main body structure of the main line 81 extends in the first direction D1, a first end of the main line 81 is connected to all of first ends of the first connection line 91, the second connection line 92, and the third connection line 93, and a second end of the main line 81 extends in the first direction D1.

In an exemplary embodiment, the first connection line 91 extends in the second direction D2, the first end of the first connection line 91 is connected to the first end of the main line 81, and a second end of the first connection line 91 extends in the second direction D2 and is connected to a first end of the first branch line 82.

In an exemplary embodiment, the first branch line 82 extends in the first direction D1, the first end of the first branch line 82 is connected to the second end of the first connection line 91, and a second end of the first branch line 82 extends in the opposite direction of the first direction D1 and is connected to a first feeder line of the third antenna unit 13.

In an exemplary embodiment, the second connection line 92 extends in the second direction D2, the first end of the second connection line 92 is connected to the first end of the main line 81, and a second end of the second connection line 92 extends in the opposite direction of the second direction D2 and is connected to a first end of the third branch line 84.

In an exemplary embodiment, the third branch line 84 extends in the first direction D1, the first end of the third branch line 84 is connected to the second end of the second connection line 92, and a second end of the third branch line 84 extends in the opposite direction of the first direction D1 and is connected to a first feeder line of the first antenna unit 11.

In an exemplary embodiment, a shape of the third connection line 93 is L-shaped, the first end of the third connection line 93 is connected to the first end of the main line 81, and a second end of the third connection line 93 is connected to a first end of the fourth connection line 94.

In an exemplary embodiment, a shape of the fourth connection line 94 is L-shaped, the first end of the fourth connection line 94 is connected to the second end of the third connection line 93, and a second end of the fourth connection line 94 is connected to a first end of the second branch line 83.

In an exemplary embodiment, the second branch line 83 extends in the first direction D1, the first end of the second branch line 83 is connected to the second end of the fourth connection line 94, and a second end of the second branch line 83 extends in the opposite direction of the first direction D1 and is connected to a first feeder line of the second antenna unit 12.

In an exemplary embodiment, the first connection line 91 includes a first connection segment i, a second connection segment j, and a third connection segment k connected sequentially. A first end of the first connection segment i is connected to the main line 81, a second end of the first connection segment i is connected to a first end of the second connection segment j, and a second end of the second connection segment j is connected to the third connection segment k. A first end of a fourth connection segment b is connected to the main line 81, a second end of the fourth connection segment b is connected to a first end of a fifth connection segment c, and a second end of the fifth connection segment c is connected to a sixth connection segment d. Herein, an impedance of the main line 81 is Zₐ, an impedance of the fourth connection segment b is Z_{b}, an impedance of the fifth connection segment c is Z_{c}, and an impedance of the sixth connection segment d is Z_{d}. Herein,

$${Z}_{c} = \sqrt{\frac{{Z}_{b}^{2}}{3 * {Z}_{a}} * {Z}_{d}} ,$$

for example, the impedance Zₐ of the main line 81 is 50Ω, and the impedance Z_{b} of the fourth connection segment b is 103Ω, the impedance Z_{c} of the fifth connection segment c is 59.5Ω, and the impedance Z_{d} of the sixth connection segment d is 50Ω.

In an exemplary embodiment, the separation wall 6 is provided with a connection hole 61, and the connection hole 61 allows the power divider circuit to pass through and connect with the feeder line. For example, the main line 81 of the one-to-three-equal power division circuit is an input feeder line, and the input feeder line passes through the connection hole 61 and is connected to the feeder line.

In an exemplary embodiment, a length of the connection hole 61 in the second direction D2 may be 5 mm or 10 mm.

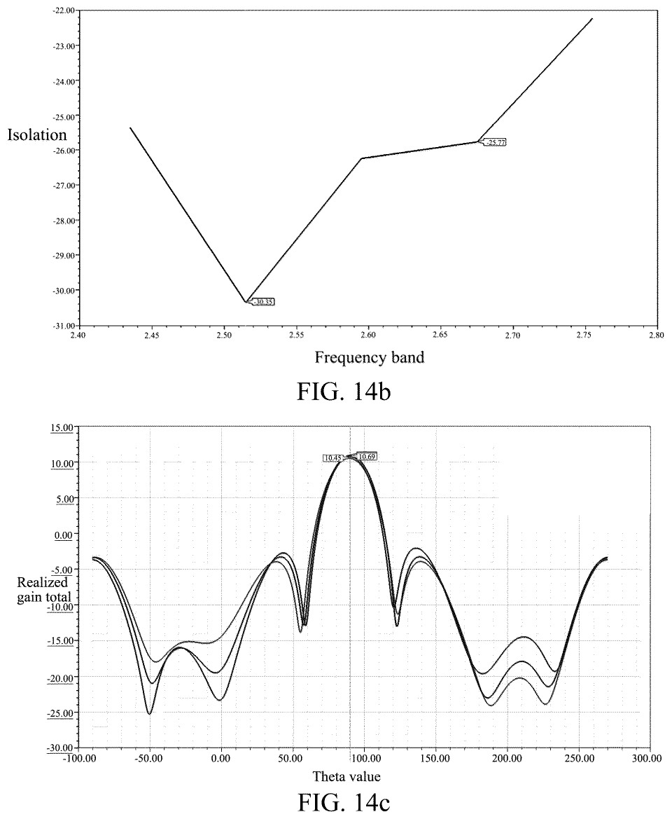

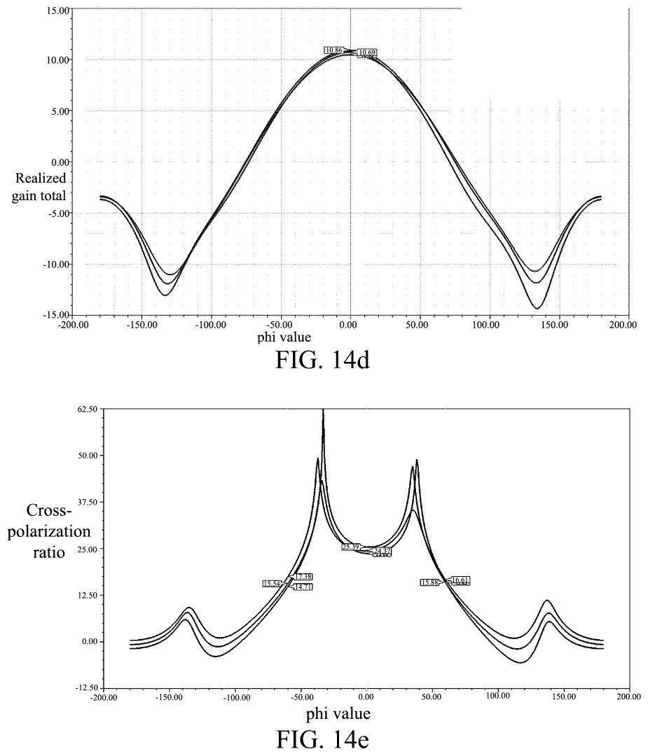

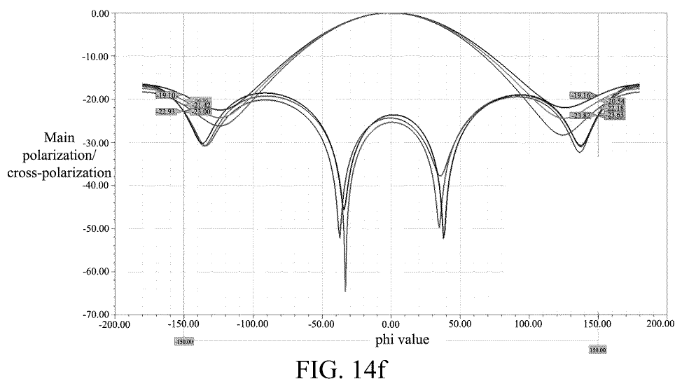

FIGS. 14a to 14f show the simulation results of the 1-to-3 antenna array shown in FIG. 12. Taking the following as an example: a size of the base substrate is 68.75 mm×56.25 mm, a size of the first radiation patch is 25 mm×25 mm, sizes of the first feeder line and the second feeder line are both 7 mm×0.82 mm, a size of the second radiation patch is 45 mm×45 mm, a distance between the second radiation patch and the first surface of the base substrate is 6.5 mm, a size of the separation wall is 16.857 mm×7.5 mm, the length of the connection hole 61 in the second direction D2 is 5 mm, a size of the first separation structure on the first radiation patch is 2 mm×0.5 mm, a size of the second separation structure on the second radiation patch is 6 mm×5 mm, and the error of the above dimensions is ±0.2 mm to ±0.5 mm, the specific explanation is as follows.

FIG. 14a is a graph of a standing wave ratio of input ports on two sides of a 1-to-3 antenna array shown in FIG. 12. An abscissa of FIG. 14a is a frequency band and an ordinate of FIG. 14a is a standing wave ratio of the input ports on two sides. As shown in FIG. 14a, in the frequency band of 2.515 GHz to 2.675 GHz, the standing wave ratio VSWR of the input ports on two sides of the 1-to-3 antenna array is ≤1.48.

FIG. 14b is a graph of an isolation between input ports on two sides of a 1-to-3 antenna array shown in FIG. 12. An abscissa of FIG. 14b is a frequency band and an ordinate of FIG. 14b is an isolation between the input ports on two sides. As shown in FIG. 14b, in the frequency band of 2.515 GHz to 2.675 GHz, the isolation S12 between the input ports on two sides of the 1-to-3 antenna array is ≤−25.77 dB.

FIG. 14c is a graph of a perpendicular plane gain and a wave width of a single port excitation of a 1-to-3 antenna array shown in FIG. 12 and the perpendicular plane is the XOZ plane in the radiation coordinate system in FIG. 12. An abscissa of FIG. 14c is a theta value, theta is an included angle with the Z axis in the radiation coordinate system in FIG. 12 and an ordinate of FIG. 14c is a realized gain total of the 1-to-3 antenna array. As shown in FIG. 14c, in the frequency band of 2.515 GHz to 2.675 GHz, the realized gain total of the 1-to-3 antenna array is ≥10.45 dBi, and the perpendicular plane wave width of the 1-to-3 antenna array is ≥260.

FIG. 14d is a graph of a horizontal plane gain and a wave width of a single port excitation of a 1-to-3 antenna array shown in FIG. 12 and the horizontal plane is the XOY plane in the radiation coordinate system in FIG. 12. An abscissa of FIG. 14d is a phi value, phi is an included angle with the X axis in the radiation coordinate system in FIG. 12, and an ordinate of FIG. 14d is a realized gain total of the 1-to-3 antenna array. As shown in FIG. 14d, in the frequency band of 2.515 GHz to 2.675 Ghz, the realized gain total of the 1-to-3 antenna array is ≥10.45 dBi, and the horizontal plane wave width of the 1-to-3 antenna array is ≥73°.

FIG. 14e is a graph of a cross-polarization ratio of a single port excitation of a 1-to-3 antenna array shown in FIG. 12 and the cross-polarization ratio is the difference between a main polarization and a cross-polarization. An abscissa of FIG. 14e is a phi value and an ordinate of FIG. 14e is a cross-polarization ratio. As shown in FIG. 14e, in the frequency band of 2.515 GHz to 2.675 Ghz, the cross-polarization ratio in an axial direction of the 1-to-3 antenna array is ≥23.66 dB, and the cross-polarization ratio in ±60° of the 1-to-3 antenna array is ≥14.71 dB.

FIG. 14f is a graph of a front-to-back ratio of a single port excitation of a 1-to-3 antenna array shown in FIG. 12. An abscissa of FIG. 14f is a phi value and an ordinate of FIG. 14f is the main polarization or cross-polarization of the 1-to-3 antenna array. The front-to-back ratio is 180° in an opposite direction of a normal direction of the 1-to-3 antenna array and the worst value of the main polarization and cross-polarization within a range of 180°+30° is taken. As shown in FIG. 14f, in the frequency band of 2.515 GHz to 2.675 Ghz, the front-to-back ratio of the 1-to-3 antenna array is ≥19.1 dB.

An embodiment of the present application also provides an electronic apparatus including the antenna unit described in any one of above embodiments. An embodiment of the present application does not specifically limit a specific form of the above electronic apparatus.

In an exemplary embodiment, the electronic apparatus may include, but is not limited to, a radar, a mobile phone, a tablet, a television, a laptop, a navigator, or the like.

The drawings of the present disclosure only involve structures involved in the present disclosure, and other structures may refer to conventional designs. The embodiments of the present disclosure, i.e., features in the embodiments, may be combined with each other to obtain new embodiments if there is no conflict.

Those of ordinary skills in the art should understand that modifications or equivalent replacements may be made to the technical solutions of the present disclosure without departing from the essence and scope of the technical solutions of the present disclosure, and shall all fall within the scope of the claims of the present disclosure.

1. An antenna unit, comprising:
a base substrate, comprising a first surface and a second surface provided opposite to each other in a thickness direction of the base substrate;
a first radiation patch, provided on the first surface of the base substrate;
a feeder line, provided on the first surface of the base substrate, the feeder line being connected to the first radiation patch; and
a second radiation patch, suspended on a side of the first radiation patch away from the base substrate; wherein an orthographic projection of the second radiation patch on the base substrate overlaps with an orthographic projection of the first radiation patch on the base substrate;
wherein at least one of the first radiation patch and the second radiation patch is provided with a separation structure.

2. The antenna unit according to claim 1, wherein at least one second separation structure is provided on the second radiation patch, and the second separation structure is a groove-like structure or a through-hole structure.

3. The antenna unit according to claim 2, wherein a shape of the groove-like structure comprises a U-shape; or
wherein a shape of the through-hole structure comprises a rectangular shape; or
wherein part or all of the second separation structure is curved in a direction towards the base substrate.

4-5. (canceled)

6. The antenna unit according to claim 2, wherein the second radiation patch comprises at least one corner part, and the second separation structure is provided in at least one corner part area of the second radiation patch; and
wherein a shape of the second radiation patch is rectangular, and second separation structures are respectively provided in four corner part areas of the second radiation patch.

7. (canceled)

8. The antenna unit according to claim 2, wherein at least one protrusion part is provided on the second radiation patch, and part or all of the second separation structure is provided on the protrusion part.

9. The antenna unit according to claim 8, wherein the protrusion part is curved in a direction towards the base substrate, and is provided obliquely relative to the second radiation patch; and
wherein a shape of the second radiation patch is polygonal, the second radiation patch comprises a first edge part and a second edge part located between adjacent first edge parts, and the protrusion part is provided on the first edge part.

10. (canceled)

11. The antenna unit according to claim 2, wherein a ratio of a first length of the second separation structure to a second length of the second separation structure is 0.5 to 2, the first length is a distance feature in a fourth direction, the second length is a distance feature in a fifth direction, the fourth direction and the fifth direction are both parallel to the base substrate, and the fourth direction intersects with the fifth direction.

12. The antenna unit according to claim 1, wherein the orthographic projection of the first radiation patch on the base substrate is located within the orthographic projection of the second radiation patch on the base substrate; or
wherein the feeder line is integrally connected with the first radiation patch.

13. (canceled)

14. The antenna unit according to claim 1, wherein an orthographic projection of the feeder line on the base substrate is located within the orthographic projection of the second radiation patch on the base substrate; or
wherein the feeder line comprises a first feeder line and a second feeder line, the first feeder line and the second feeder line being located on the same side of the first radiation patch.

15. (canceled)

16. The antenna unit according to claim 14, wherein at least one first separation structure is provided on the first radiation patch, the first separation structure, the first feeder line, and the second feeder line are located on the same side of the first radiation patch, and the first separation structure is located between the first feeder line and the second feeder line.

17. The antenna unit according to claim 16, wherein the first separation structure comprises a groove-like structure.

18. The antenna unit according to claim 17, wherein a ratio of a third length of the first separation structure to a fourth length of the first separation structure is 1 to 4, the third length is a distance feature in a second direction, the fourth length is a distance feature in a first direction, the first direction and the second direction are both parallel to the base substrate, and the first direction intersects with the second direction; or
wherein a distance from a central axis of the first separation structure to an edge of the first feeder line is L1, a distance from the central axis of the first separation structure to an edge of the second feeder line is L2, and a ratio of the L2 to the L1 is 3 to 4.

19. (canceled)

20. The antenna unit according to claim 1, wherein a shape of the first radiation patch comprises a rectangular shape, and at least one corner part of the first radiation patch is a rounded corner.

21. The antenna unit according to claim 1, wherein at least one separation wall is provided on an edge part of the base substrate, the separation wall protruding from the first surface of the base substrate.

22. The antenna unit according to claim 21, wherein the base substrate comprises a first edge and a second edge provided opposite to each other, separation walls are provided at two ends of the first edge and two ends of the second edge, respectively; or, the separation walls are provided at a middle of the first edge and a middle of the second edge, respectively; or
wherein a connection hole is provided in the separation wall.

23. (canceled)

24. The antenna unit according to claim 1, further comprising a reflection plate provided on the second surface of the base substrate, the reflection plate being made of a conductive material, and the reflection plate being grounded; or
wherein the base substrate is a glass base substrate.

25. (canceled)

26. An antenna array comprising a plurality of antenna units as claimed in claim 1, and a power divider circuit, the power divider circuit comprising a one-to-multiple-equal power division circuit, the one-to-multiple-equal power division circuit comprising a main line and a plurality of branch lines, first ends of the plurality of branch lines being electrically connected to the main line, second ends of the plurality of branch lines being connected in one-to-one correspondence with feeder lines of the plurality of antenna units, the power divider circuit being configured to provide signals of substantially equal power to the plurality of antenna units.

27. The antenna array according to claim 26, comprising three antenna units, wherein the power divider circuit comprises a one-to-three-equal power division circuit, the one-to-three-equal power division circuit comprises a main line and three branch lines, first ends of the three branch lines are connected to the main line, and second ends of the three branch lines are connected in one-to-one correspondence with the feeder lines of the three antenna units.

28. An electronic apparatus, comprising the antenna unit of claim 1.

29. A method for preparing an antenna unit, comprising:
forming a first radiation patch and a feeder line on a base substrate, the feeder line being connected to the first radiation patch; and
forming a second radiation patch on a side of the first radiation patch away from the base substrate, wherein the second radiation patch is suspended on the first radiation patch, an orthographic projection of the second radiation patch on the base substrate overlaps with an orthographic projection of the first radiation patch on the base substrate, and at least one of the first radiation patch and the second radiation patch is provided with a separation structure.
